(19) United States
(12) Patent Application Publication
(10) Pub. No.: US 2026/0088652 A1
(43) Pub. Date: Mar. 26, 2026

(54) NON-INVASIVE HARMONIC MAGNETIC FIELD ENERGY HARVESTING DEVICE FOR HIGH VOLTAGE DIRECT CURRENT TRANSMISSION LINE

(71) Applicant: XI'AN JIAOTONG UNIVERSITY, Xi'an (CN)

(72) Inventors: Aijun Yang, Xi'an (CN); Xiaohua Wang, Xi'an (CN); Zhu Liu, Xi'an (CN); Likai Zheng, Xi'an (CN); Siyu Bao, Xi'an (CN); Jifeng Chu, Xi'an (CN); Mingzhe Rong, Xi'an (CN)

(21) Appl. No.: 19/250,587

(22) Filed: Jun. 26, 2025

(30) Foreign Application Priority Data
Sep. 25, 2024 (CN) 2024113453893

(51) Int. Cl. H02J 50/00; H01F 27/24; H01F 27/28; H02J 3/36

(52) U.S. Cl. CPC H02J 50/001; H01F 27/24; H01F 27/28; H02J 3/36

(57) ABSTRACT

The present disclosure proposes a non-invasive harmonic magnetic field energy harvesting device for a high voltage direct current (HVDC) transmission line, and the device includes an arc-shaped magnetic core and flux collectors; the arc-shaped magnetic core is located at the center of the device and the flux collectors are located at both ends of the arc-shaped magnetic core, and the device is placed near the transmission line without being snapped onto the transmission line. The designed arc-shaped magnetic core is a non-closed arc-shaped magnetic core with relatively low effective permeability, which can effectively prevent saturation of the magnetic core caused by a strong direct current. When the magnetic core is unsaturated, the alternating magnetic field generated by the harmonic current will generate an induced voltage in the coil based on electromagnetic induction, thereby enabling energy harvesting.

### CROSS-REFERENCE TO RELATED APPLICATION

This application claims priority from the Chinese patent application 2024113453893 filed Sep. 25, 2024, the content of which is incorporated herein in the entirety by reference.

### TECHNICAL FIELD

The present disclosure belongs to the technical field of high voltage cable transmission, and particularly relates to a non-invasive harmonic magnetic field energy harvesting device for a high voltage direct current transmission line.

### BACKGROUND

Due to the lack of abundant alternating electric and magnetic fields in high voltage direct current (HVDC) transmission lines, the traditional techniques for collecting magnetic and electric field energy, which are widely used in alternating current transmission lines, are no longer applicable. Furthermore, solar and wind energy collectors are susceptible to weather conditions, resulting in unstable output power. Consequently, there has been a persistent lack of efficient and stable energy harvesting methods for HVDC transmission lines, hindering the deployment of self-powered sensors within these lines. In the rectification and inversion stages of HVDC transmission systems, the limited switching frequency of electronic switching devices leads to the coexistence of the direct current and the harmonic current in the HVDC transmission lines.

### SUMMARY

In order to solve the above problems, the present disclosure introduces, for the first time, a novel method of harvesting the harmonic magnetic field energy from the HVDC transmission lines using a non-intrusive harmonic magnetic field energy harvesting device for the HVDC transmission line. Traditional magnetic energy harvesters based on current transformers may experience deep saturation of their magnetic cores due to the strong DC in the HVDC transmission lines, rendering them unable to harvest the magnetic field energy of the harmonic current. The arc-shaped magnetic core designed in this disclosure, due to its non-closed structure and consequently lower effective permeability, can effectively avoid saturation caused by the strong direct current. When the magnetic core is unsaturated, the alternating magnetic field generated by the harmonic current will generate an induced voltage in the coil based on electromagnetic induction, thereby enabling energy harvesting.

The technical solutions adopted by the present disclosure to solve its technical problems are:
a non-invasive harmonic magnetic field energy harvesting device for a high voltage direct current (HVDC) transmission line, including: an arc-shaped magnetic core and flux collectors;
wherein the arc-shaped magnetic core is located at the center of the device and the flux collectors are located at both ends of the arc-shaped magnetic core.

Preferably, the arc-shaped magnetic core is a non-closed arc-shaped magnetic core.

Preferably, the effective permeability of the non-closed arc-shaped magnetic core is much lower than that of a closed toroidal magnetic core.

Preferably, the device harvests alternating current harmonic magnetic field energy from the HVDC transmission line based on the principle of electromagnetic induction.

Preferably, a method based on the device includes the following steps: denoting the external direct current magnetic field strength generated by a direct current in the HVDC transmission line as H_{e,dc}, and denoting an effective value of the external alternating magnetic field strength generated by a harmonic current as H_{e,ac}; and

obtaining H_{e,dc} and H_{e,ac} through the following formulas:

$${H}_{e , dc} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} )$$

$${H}_{e , a c} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} ) ,$$

wherein I_{dc} and I_{ac} are the effective values of the direct current and the harmonic current in the line, respectively, r is the radius of the arc-shaped magnetic core, aₚ is the side length of the flux collector, and ρ represents a distance from the center of the cross section of the HVDC transmission line to any point on the flux collector.

Preferably, the device further includes: a coil and a load resistor.

Preferably, the alternating magnetic field generated by the harmonic current generates an induced voltage in the coil based on the principle of electromagnetic induction and outputs power to the load resistor.

Technical advantages of the present disclosure are as follows:

1. Compared to traditional magnetic energy harvesters based on current transformers, this disclosure can effectively prevent the magnetic core from being saturated by the strong direct current, thus ensuring the ability to harvest the harmonic magnetic field energy.

2. The alternating magnetic field produced by the harmonic current generates an induced voltage in the coil based on the principle of electromagnetic induction and outputs power to the load. The energy harvesting process based on the principle of electromagnetic induction is not affected by weather conditions.

### BRIEF DESCRIPTION OF DRAWINGS

FIG. 1 is a comparison diagram of two magnetic core structures: a magnetic field energy harvester based on a current transformer and a non-intrusive direct current harmonic magnetic field energy harvesting device according to an embodiment of the present disclosure;

FIG. 2 is a cross-sectional view of the non-invasive direct current harmonic magnetic field energy harvesting device having an arc-shaped magnetic core according to an embodiment of the present disclosure;

FIG. 3 is a schematic diagram of the magnetization state inside the arc-shaped magnetic core under the combined action of the direct current and the harmonic current according to an embodiment of the present disclosure;

FIG. 4 is an equivalent circuit diagram of the non-invasive direct current harmonic magnetic field energy harvesting device according to an embodiment of the present disclosure;

FIG. 5 is a schematic diagram of the content of different harmonic currents with respect to the direct current at a converter station A according to an embodiment of the present disclosure;

FIG. 6 is induced voltage waveforms of the non-invasive direct current harmonic magnetic field energy harvesting device with different magnetic core materials under different direct currents Ide (corresponding to different lac) according to an embodiment of the present disclosure;
wherein, FIG. 6 (a): permalloy; FIG. 6 (b): Mn—Zn ferrite; and

FIG. 7 is a schematic diagram of V_{oc}, P_{L} and B_{c,dc} for the non-invasive direct current harmonic magnetic field energy harvesting device with a Mn—Zn ferrite magnetic core (a_{c}=1.6 cm) under different direct currents I_{dc} (I_{ac}=0.3% I_{dc}) according to an embodiment of the present disclosure.

### DETAILED DESCRIPTION OF THE INVENTION

Specific embodiments of the present disclosure will be described in detail below with reference to the accompanying drawings 1 to 7. While specific embodiments of the present disclosure are illustrated in the drawings, it should be understood that the present disclosure may be embodied in various forms and should not be limited to the embodiments set forth herein. Rather, these embodiments are provided in order to enable a more thorough understanding of the present disclosure and to fully convey the scope of the present disclosure to those skilled in the art.

It should be noted that certain terms are used throughout the description and claims to refer to certain components. It will be appreciated by those skilled in the art that different terms may be used to refer to the same component. The present description and claims do not use differences in terms as a way to distinguish components, but use differences in functions of components as a criterion for distinguishing them. “Comprise” or “comprising”, as referred to throughout the description and claims, is an open term that should be interpreted as “including, but not limited to”. The following description is to describe preferred embodiments for carrying out the present disclosure, but the description is for the purpose of general principles of the description and is not intended to limit the scope of the present disclosure. The protection scope of the present disclosure is intended as defined by the appended claims.

In order to facilitate understanding of the embodiments of the present disclosure, specific embodiments will be further explained below with reference to the accompanying drawings as examples, and each of the accompanying drawings does not constitute a limitation of the embodiments of the present disclosure.

The present disclosure provides a non-invasive harmonic magnetic field energy harvesting device for a high voltage direct current (HVDC) transmission line, and the device includes:
an arc-shaped magnetic core and flux collectors;
wherein the arc-shaped magnetic core is located at the center of the device and the flux collectors are located at both ends of the arc-shaped magnetic core.

Preferably, the arc-shaped magnetic core is a non-closed arc-shaped magnetic core.

Preferably, the effective permeability of the non-closed arc-shaped magnetic core is much lower than that of the closed toroidal magnetic core.

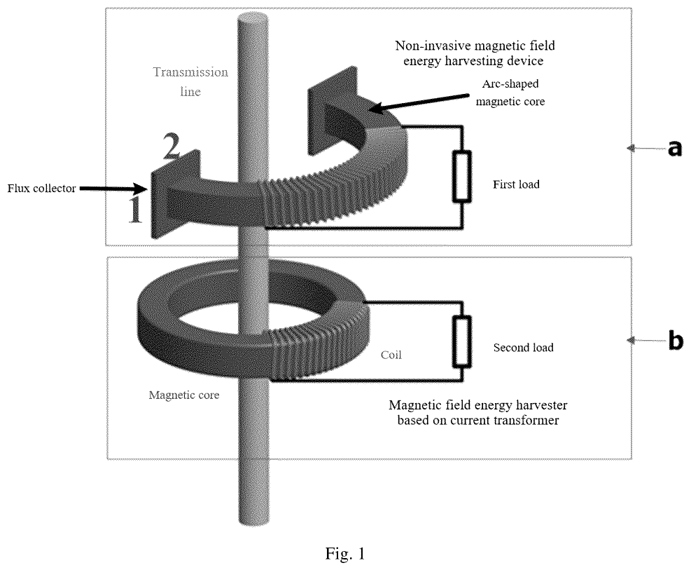

With respect to the above embodiments, it should be noted that, compared to a traditional magnetic field energy harvester based on a current transformer, the non-invasive direct current harmonic magnetic field energy harvesting device disclosed in the present disclosure effectively avoids magnetic core saturation due to the strong direct current, and a comparison of the two magnetic core structures is shown in FIG. 1, wherein:
in the traditional solutions, the magnetic field energy harvesters based on the current transformers are used in the alternating current transmission lines, which use closed toroidal magnetic cores. As shown by b in FIG. 1, since b must be snapped on or sleeve the transmission line in an intrusive manner during use, it is an intrusive magnetic field energy harvester. However, this is not suitable for the HVDC transmission lines due to the following reason: the closed toroidal magnetic core has high effective permeability, and when applied to the HVDC transmission lines, the strong direct current magnetic field generated by the direct current causes the magnetic core to saturate, thus preventing the generation of the induced voltage in the coil.

Accordingly, the present disclosure discloses a non-invasive direct current harmonic magnetic field energy harvesting device that no longer employs a closed toroidal magnetic core, but instead employs an open, non-closed arc-shaped magnetic core. Referring to FIG. 1, such a non-closed arc-shaped magnetic core can be placed near a transmission line without being intrusively snapped on the transmission line, as shown by a in FIG. 1, thus a is a non-intrusive magnetic field energy harvester.

Further, as shown by a in FIG. 1, the arc-shaped magnetic core is provided with a coil, and two flux collectors are connected to both ends of the arc-shaped magnetic core, respectively. Illustratively, the end face of the arc-shaped magnetic core is square, and the end faces of the two flux collectors are square with a side length greater than the side length of the arc-shaped magnetic core. (In order to reduce eddy current losses, commercial arc-shaped magnetic cores are typically constructed by stacking a plurality of sheets, and rectangular end faces facilitate manufacturing, thus, in this disclosure, the end face of the arc-shaped magnetic core is selected to be square. Note: it does not necessarily need to be square; rectangles with unequal length and width, or even irregular shapes, are also acceptable. Here, a square is used as an example. The end face shape of the flux collector should match the arc-shaped magnetic core but be larger in size. On the one hand, a larger end face of the flux collector can collect more magnetic fields to increase output power. On the other hand, the space created by the difference in end face sizes between the arc-shaped magnetic core and the flux collector is used for winding the coil, with the cross-section of the coil not exceeding the end face of the flux collector. Furthermore, both the length and width should be proportionally larger compared to the end face of the magnetic core. Theoretically, the larger the length and width, the more magnetic fields are collected, and the higher the output power. However, two considerations must be taken into account: 1. Increasing the length and width also means increasing the size of the device, so the improvement in output power comes at the cost of increased volume. 2. During actual installation, the length and width are constrained by the installation scenario. For example, in FIG. 1, the side length 1 parallel to the transmission line can be made appropriately larger, but the side length 2 perpendicular to the transmission line cannot be too large, as it may come into contact with the transmission line itself, which is not allowed. Overall, the length and width can be made as large as possible to increase the overall output power of the device, but the aforementioned limitations must also be taken into consideration.

It should be noted that in the present disclosure, since the arc-shaped magnetic core acts as a non-closed magnetic core, when magnetized in a magnetic field, two opposite magnetic poles are generated at both ends of the arc-shaped magnetic core. The two magnetic poles generate a demagnetizing field inside the arc-shaped magnetic core in a direction opposite to the external magnetic field. The demagnetizing field significantly reduces the magnetic induction strength inside the arc-shaped magnetic core, resulting in a significant reduction in the effective permeability of the arc-shaped magnetic core. Thus, the non-closed arc-shaped magnetic core has a strong resistance to saturation.

When the magnetic field generated by the direct current does not saturate the magnetic core, the alternating magnetic field generated by the harmonic current in the magnetic core will generate an induced voltage in the coil based on the principle of electromagnetic induction and output power to the load. That is, the flux density of the magnetic field generated by the direct current flowing in the transmission line under the influence of the arc-shaped magnetic core should be less than the material saturation flux density of the arc-shaped magnetic core.

Further, since the non-closed magnetic core is magnetized in a magnetic field, two opposite magnetic poles are generated at both ends of the non-closed magnetic core, the two magnetic poles generate a demagnetizing field inside the magnetic core in a direction opposite to the external magnetic field. The demagnetizing field significantly reduces the magnetic field strength inside the magnetic core, and thus the effective permeability of the magnetic core is significantly reduced.

Illustratively, the effective permeability of the non-closed arc-shaped magnetic core made of the Mn—Zn ferrite material is typically in the range of 20-100 (depending on the specific geometrical parameters of the magnetic core, typically on the order of tens), while the effective permeability of the closed toroidal shaped core made of the Mn—Zn ferrite material is typically 2000 or above. Typically, the effective permeability of the non-closed arc-shaped magnetic core is less than or equal to at least one-twentieth of that of the closed toroidal magnetic core.

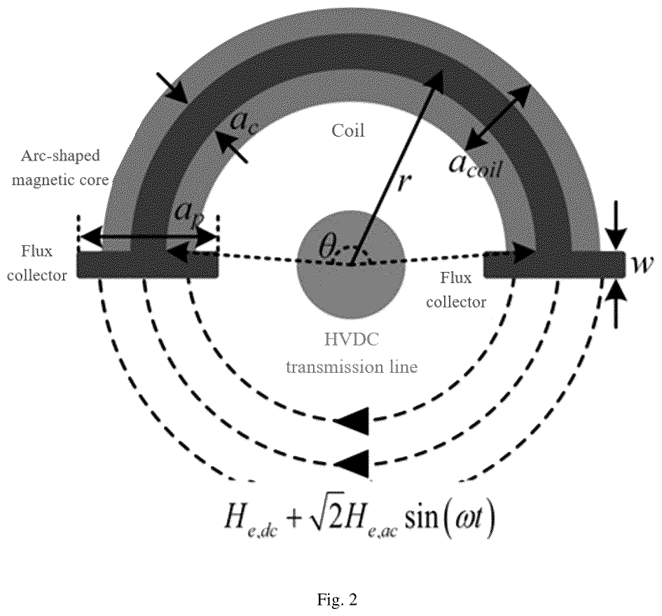

A cross-section of the non-invasive direct current harmonic magnetic field energy harvesting device with an arc-shaped magnetic core shown in FIG. 1 is shown in FIG. 2. It should be noted that the coil length should be as large as possible to fill the space outside the magnetic core to increase the load power. FIG. 1 is only a schematic diagram of the structure. An analysis of the working principle will be described below based on the detailed structure shown in FIG. 2.

The non-invasive direct current harmonic magnetic field energy harvesting device disclosed in the present disclosure in its entirety includes a central arc-shaped magnetic core, flux collectors at both ends, a coil, and a load resistor. Referring to FIG. 1, the first load is the load resistor in the disclosed solution, and the second load is the load resistor in the conventional solution.

In addition, the non-invasive direct current harmonic magnetic field energy harvesting device disclosed in the present disclosure harvests the alternating current harmonic magnetic field energy in the HVDC transmission line based on the principle of electromagnetic induction.

Referring to FIG. 2, a cross-sectional view of the disclosed non-invasive direct current harmonic magnetic field energy harvesting device is shown. An explanation of the specific working principle is as follows:

a_{c}, r, and θ are set to be the side length, radius, and radian of the arc-shaped magnetic core, respectively; aₚ and w are the side length and thickness of the flux collector, a_{coil} is the height of the coil, H_{e,dc} is the external direct current magnetic field strength generated by the direct current in the HVDC transmission line, and H_{e,ac} is the effective value of the external alternating magnetic field strength generated by the harmonic current in the HVDC transmission line. The external direct current magnetic field generated by the direct current is superimposed with the external alternating magnetic field generated by the harmonic current to form a total magnetic field applied to the flux collector with an instantaneous value of H_{e,dc}+√2H_{e,ac} sin (ωt), ω being the angular frequency of the harmonic current.

The calculation formulas for H_{e,dc} and H_{e,ac} are:

$${H}_{e , dc} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} ) \qquad ( 1 )$$

$${H}_{e , a c} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} ) , \qquad ( 2 )$$

wherein I_{dc} and I_{ac} are the effective values of the direct current and the harmonic current in the line, respectively, and ρ represents a distance from the center of the cross section of the HVDC transmission line to any point on the flux collector. It should be noted that only the magnetic field collected by the flux collector can enter the interior of the arc-shaped magnetic core, and therefore the minimum and maximum values of ρ should be the minimum and maximum values, respectively, of the distance from any point on the end face of the flux collector to the center of the cross-section of the HVDC transmission line, i.e. the value of ρ is in the range of r-aₚ/2 to r+aₚ/2.

Further, the current flowing in the HVDC transmission line includes a direct current component and a harmonic current component, and the magnitude of the direct current and the harmonic current flowing in the line is determined by the operating conditions of the power system itself, independent of the arc-shaped magnetic core and coil of the present device. This device is intended only to harvest the energy of the alternating magnetic field generated by the harmonic current in the line, while avoiding saturation of the magnetic core by the direct current magnetic field generated by the direct current in the line. Therefore, I_{dc} and I_{ac} are determined by the operating state of the HVDC transmission line itself, and are not affected by the device of the present disclosure. In contrast, it is the magnitude of I_{dc} and I_{ac} that determines the strengths H_{e,dc} and H_{e,ac} of the direct current and harmonic current magnetic fields, which in turn determine the direct current bias point B_{c,dc}, the induced voltage V_{oc}, the load power P_{L}, and the like of the magnetic core in the subsequent analysis.

The non-invasive direct current harmonic magnetic field energy harvesting device disclosed in the present disclosure generates an induced voltage in the coil provided at the arc-shaped magnetic core and outputs power to the load based on the principle of electromagnetic induction. In connection with a in FIG. 1, according to the principle of electromagnetic induction, the magnitude of the induced voltage of the coil depends on the rate of change of the magnetic induction strength in the arc-shaped magnetic core. When the frequency of the harmonic current is constant, a higher harmonic content results in a larger magnitude of magnetic induction strength generated inside the arc-shaped magnetic core, and consequently a larger absolute value of the rate of change of the magnetic induction strength, leading to a higher induced voltage in the coil and higher load power. Similarly, when the harmonic current content is constant, a higher frequency of the harmonic current results in a larger absolute value of the rate of change of the magnetic induction strength, leading to a higher induced voltage in the coil and higher load power.

In particular, the harmonic current content determines the magnetic field strength H_{e,ac} it produces. As can be seen from the following formula (9), the coil induced voltage is positively correlated with the magnetic field strength Hear and the magnetic field frequency f=(ω/2π) generated by the harmonic current, and the higher the coil induced voltage, the greater the load power.

Therefore, the harmonic magnetic field energy level is positively correlated with the content and frequency of the harmonic current, and to simplify the analysis, the following description and verification of the present disclosure will be exemplified by the 12th harmonic current.

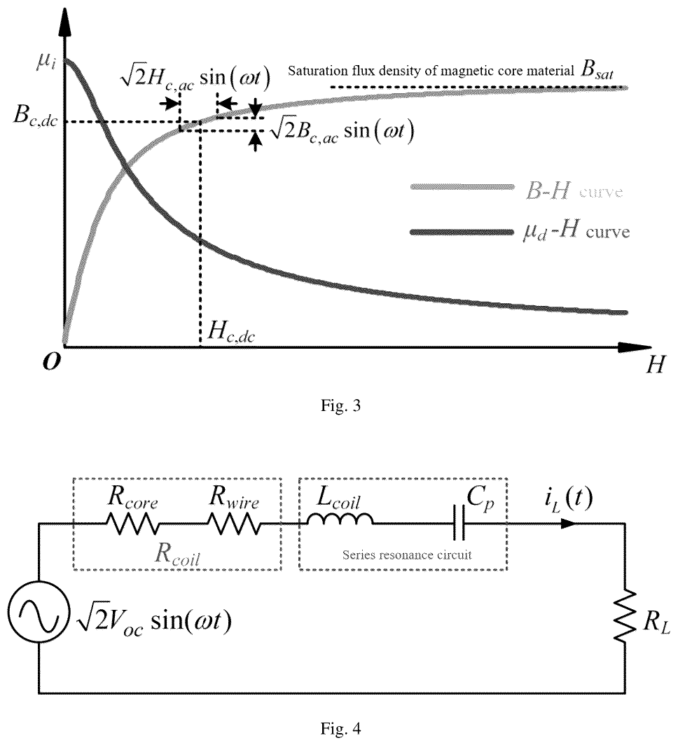

Referring to FIG. 3, which shows the magnetization state inside the arc-shaped magnetic core under the combined action of the direct current and the harmonic current. The alternating magnetic field generated by the harmonic current causes the magnetic field inside the magnetic core to vary near a direct current bias point B_{c,dc}, which is generated by the direct current. Due to the presence of a demagnetizing field in the non-closed magnetic core, the direct current magnetic field H_{c,dc} inside the magnetic core is much lower than the external direct current magnetic field H_{e,dc}:

$${H}_{c , dc} = {H}_{e , dc} - {H}_{d , dc} , {H}_{d , dc} = {D}_{M} \times {M}_{dc} \qquad ( 3 )$$

wherein H_{d,dc} is the direct current demagnetizing field, D_{M} is the demagnetization coefficient, and M_{dc} is the direct current magnetization strength.

According to a curve B-H of FIG. 3, when the disclosed device operates, the arc-shaped magnetic core will operate near the direct current bias point B_{c,dc}, wherein:

$${B}_{c , dc} = {μ}_{0} {μ}_{e , dc} {H}_{e , dc} < {B}_{sat} \qquad ( 4 )$$

wherein μ₀ is the vacuum permeability, μ_{e,dc} is the direct current effective permeability, and Bₛₐₜ is the saturation flux density of the magnetic core material.

μ_{e,dc} can be calculated as:

$${μ}_{e , dc} = \frac{{[ ( θ r + 2 w + {a}_{p} - {a}_{c} ) / θ r ]}^{1 / 3} \cdot ( {B}_{c , dc} / {μ}_{0} {H}_{c , dc} )}{1 + \frac{1.7}{4 {d}^{3} {m}^{1.87}} ( ln \frac{1 + d}{1 - d} - 2 d ) ( \frac{{B}_{c , dc}}{{μ}_{0} {H}_{c , dc}} - 1 )} \qquad ( 5 )$$

wherein m=(θr+2w+aₚ−a_{c})/a_{c}, d=(1−m⁻²)^{1/2}.
wherein B_{c,dc} must be less than the saturation flux density Bₛₐₜ of the magnetic core material, the present disclosure can determine whether the magnetic core is in saturation using formulas (1) (4) and (5).

Further, the direct current bias point B_{c,dc} is obtained by substituting the formulas (1) and (5) into the formula (4). If B_{c,dc}<Bₛₐₜ, the magnetic core is not saturated and an induced voltage is generated in the coil by the alternating magnetic field generated by the harmonic current, whereas the magnetic core enters saturation and no induced voltage is generated in the coil. When an induced voltage is generated in the coil, the non-closed arc-shaped magnetic core is placed near the transmission line, and the distance range is determined as follows:

According to FIG. 2, the arc-shaped magnetic core has a radius r, and its center coincides with the center of the cross-section of the transmission line. The minimum distance from the flux collectors at both ends of the arc-shaped magnetic core to the center of the cross-section of the transmission line is r−aₚ/2, which should be larger than the radius of the cross-section of the transmission line in order to ensure installation feasibility.

The coil induced voltage is generated by an alternating magnetic field generated by the harmonic current. The external alternating magnetic field generated by the harmonic current is √2H_{e,ac} sin (ωt), and the instantaneous value of the alternating magnetic field generated inside the magnetic core by the external alternating magnetic field is √2H_{c,ac} sin (ωt), wherein H_{c,ac} is the effective value of the alternating magnetic field inside the magnetic core and ω is the angular frequency of the harmonic current. The instantaneous value of the alternating current magnetic induction strength generated inside the magnetic core by the alternating magnetic field inside the magnetic core is √2B_{c,ac} sin (ωt), wherein B_{c,ac} is the effective value of the alternating current magnetic induction strength inside the magnetic core. B_{c,ac} can be calculated as:

$${B}_{c , ac} = {μ}_{0} {μ}_{e , ac} {H}_{e , ac} \qquad ( 6 )$$

wherein the alternating current effective permeability μ_{e,ac} can be expressed as:

$${μ}_{e , a c} = \frac{{[ ( θ r + 2 w + {a}_{p} - {a}_{c} ) / θ r ]}^{1 / 3} \cdot {μ}_{d} {\vert}_{H = {H}_{c , dc}}}{1 + \frac{1.7}{4 {d}^{3} {m}^{1.87}} ( ln \frac{1 + d}{1 - d} - 2 d ) ( {μ}_{d} {\vert}_{H = {H}_{c , dc}} - 1 )} \qquad ( 7 )$$

wherein μ_{d} is the differential relative permeability of the magnetic core material. When the differential relative permeability of the magnetic core material is high, the effective permeability of the non-closed magnetic core is hardly affected by changes in the differential relative permeability. Thus, referring to FIGS. 1 and 2, for the arc-shaped magnetic core shown by a in FIG. 1, when the arc-shaped magnetic core is not saturated, μ_{e,ac} can be estimated as μ_{e,dc}:

$${μ}_{e , dc} \approx {μ}_{e , ac} \approx \frac{{[ ( θ r + 2 w + {a}_{p} - {a}_{c} ) / θ r ]}^{1 / 3} \cdot {μ}_{i}}{1 + \frac{1.7}{4 {d}^{3} {m}^{1.87}} ( ln \frac{1 + d}{1 - d} - 2 d ) ( {μ}_{i} - 1 )} \qquad ( 8 )$$

wherein μᵢ is the initial relative permeability of the magnetic core material. FIG. 4 is an equivalent circuit of the non-invasive direct current harmonic magnetic field energy harvesting device. V_{oc} is the effective value of the coil induced voltage, which can be expressed as:

$${V}_{oc} = ω {NA}_{core} {B}_{c , ac} = ω {NA}_{core} {μ}_{0} {μ}_{e , ac} {H}_{e , ac} \qquad ( 9 )$$

wherein ω is the magnetic field angular frequency, N is the number of coil turns, and A_{core} is the cross-sectional area of the magnetic core. As previously described, via the formula (9), the coil induced voltage is positively correlated with the magnetic field strength H_{e,ac} and the magnetic field frequency f=(ω/2π) generated by the harmonic current, the higher the coil induced voltage, the greater the load power. Thus, the harmonic magnetic field energy level is positively correlated with the content and frequency of the harmonic current.

In FIG. 4, the coil resistor R_{coil} includes a magnetic core loss resistor R_{core} and a wire resistor R_{wire}. The frequency of the harmonic current in the HVDC transmission line is mainly 1 kHz or below, and the generated alternating magnetic field is a low frequency magnetic field, and the magnetic core eddy current loss and hysteresis loss are negligible at the low frequency condition. Thus, R_{coil} is approximately equal to R_{wire}.

Furthermore, in another embodiment,

The device further includes a compensation capacitor.

This is to form a series resonance circuit by the compensation capacitor and the coil inductor in order to enhance power transmission efficiency.

For ease of illustration, the compensation capacitor Cₚ forms the series resonance circuit with the coil inductor L_{coil} to improve power transfer efficiency:

$${L}_{coil} = {μ}_{0} {μ}_{e , ac} {N}^{2} {A}_{core} / {l}_{coil} , {C}_{p} = 1 / {ω}^{2} {L}_{coil} \qquad ( 10 )$$

wherein l_{coil} is the coil length, N is the number of coil turns, and A_{core} is the cross-sectional area of the magnetic core.

As can be seen from the equivalent circuit shown in FIG. 4, when the compensation capacitor Cₚ is not added, the inductive reactance jωL_{coil} of the coil inductor increases the overall impedance of the circuit, thereby reducing the load current i_{L} and the load power P_{L}. With the introduction of the compensation capacitor forming the series resonance circuit with the coil inductor, the capacitive reactance 1/jωCₚ cancels out the inductive reactance jωL_{coil} of the coil inductor, and the load current i_{L} and load power P_{L} will increase.

At impedance matching, i.e. the load resistor R_{L} is equal to the coil resistor R_{coil}, the load power P_{L} can be expressed as:

$${P}_{L} = {V}_{oc}^{2} / 4 {R}_{coil} \qquad ( 11 )$$

wherein V_{oc} is the effective value of the coil induced voltage.

When the HVDC transmission line is of a certain level or parameter, specifically for ±500k V HVDC transmission lines,
the parameters of the non-intrusive harmonic magnetic field energy harvesting device for the HVDC transmission line are shown in Table I:

TABLE I
the parameters of the non-intrusive harmonic magnetic field
energy harvesting device for the HVDC transmission line

| Parameter | | Value | | Parameter | | Value | |
|---|---|---|---|---|---|---|---|
| Magnetic core | | Permalloy/ | | Magnetic core | a_{c} | 0.8 | cm |
| material | | Mn—Zn ferrite | | side length | | | |
| Magnetic core | r | 5 | cm | Thickness of | w | 1 | mm |

| | | | | | | |
|---|---|---|---|---|---|---|
| radius | | | harvesting device | | | |
| Magnetic core | θ | π | Side length of | aₚ | 3 | cm |
| radian | | | harvesting device | | | |

| | | | | | | |
|---|---|---|---|---|---|---|
| Coil radius | r_{w} | 0.5 | mm | Number of coil | N | 2000 |
| | | | | turns | | |

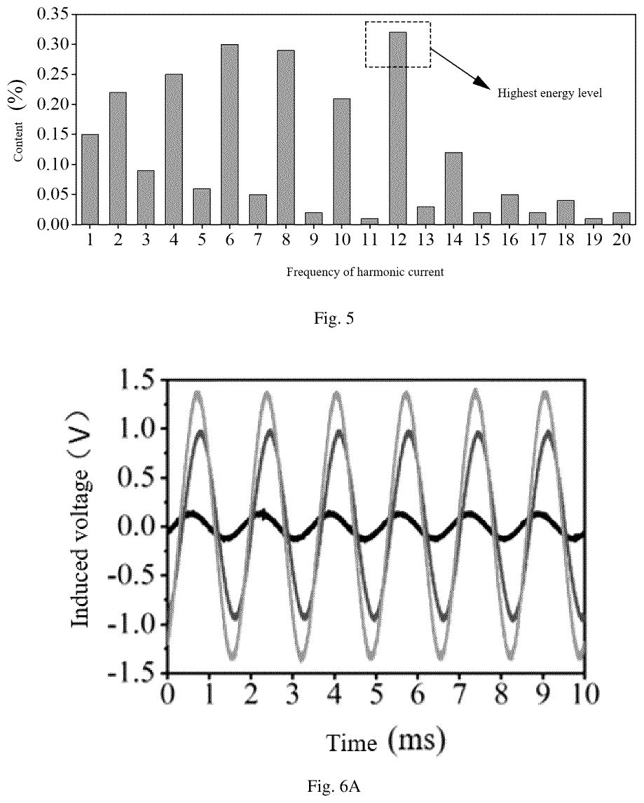

FIG. 5 is a schematic diagram of the content of different harmonic currents with respect to the direct current at a converter station A. Since the energy level of the harmonic magnetic field is positively correlated with both the content and frequency of the harmonic current, considering both factors, the 12th harmonic current in FIG. 5 exhibits the highest magnetic field energy level. Taking the 12th harmonic current as an example, experimental validation is conducted to demonstrate the effectiveness of the device disclosed in this disclosure. According to FIG. 5, during the experiment, the frequency of the harmonic current is set to 600 Hz, and the effective value I_{ac} of the harmonic current is consistently maintained at 0.3% of the effective value I_{dc} of the direct current.

FIG. 6 is induced voltage waveforms of the non-invasive harmonic magnetic field energy harvesting device for the HVDC transmission line with different magnetic core materials under different direct currents I_{dc} (corresponding to different I_{ac}), where FIG. 6(a) shows the results for permalloy, and FIG. 6(b) shows the results for Mn—Zn ferrite. Permalloy and Mn—Zn ferrite are commonly used magnetic core materials. The induced voltage of the non-invasive harmonic magnetic field energy harvesting device for the HVDC transmission line with a permalloy magnetic core increases approximately linearly with the direct current, which is consistent with theoretical analysis. However, when Ide is 1000A, the induced voltage of the non-invasive harmonic magnetic field energy harvesting device for the HVDC transmission line with an Mn—Zn ferrite magnetic core is extremely low. This is primarily due to magnetic core saturation. When I_{dc} is 1000A, the estimated direct current bias point B_{c,dc} is close to the saturation flux density Bₛₐₜ of Mn—Zn ferrite (approximately 0.52T), resulting in extremely low effective magnetic permeability and induced voltage of the magnetic core. In contrast, the Bₛₐₜ Of permalloy (approximately 0.75T) is higher than that of Mn—Zn ferrite, and the magnetic core remains in an unsaturated state.

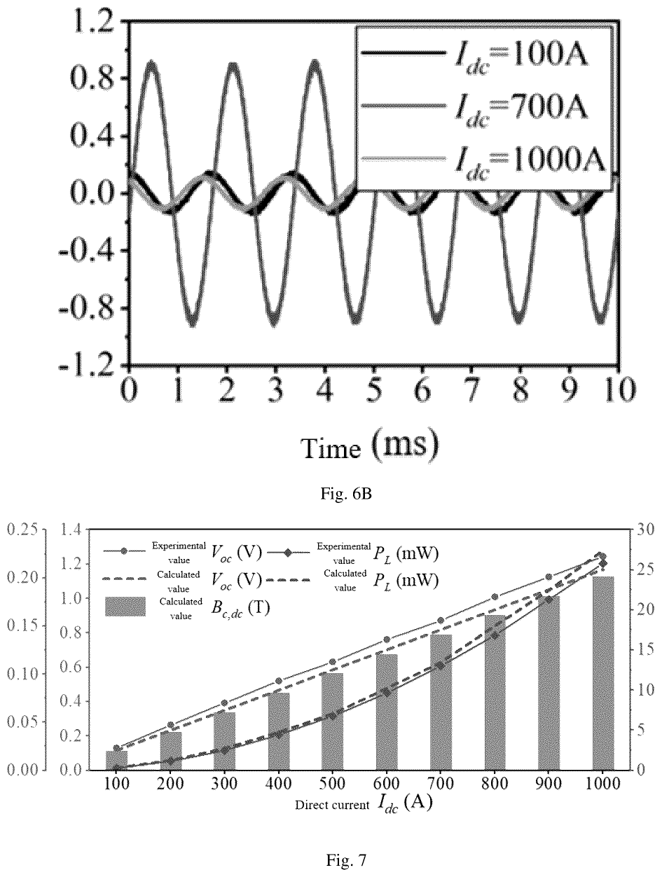

FIG. 7 shows various representations of V_{oc}, P_{L} and B_{c,dc} for the non-invasive harmonic magnetic field energy harvesting device for the HVDC transmission line with the Mn—Zn ferrite magnetic core (a_{c}=1.6 cm) under different direct currents I_{dc} (I_{ac}=0.3% I_{dc}). As shown, increasing the cross-sectional area A_{core} of the magnetic core reduces its effective permeability and thereby enhances the magnetic core's ability to withstand saturation. The side length a_{c} of the Mn—Zn ferrite magnetic core is increased from 0.8 cm to 1.6 cm, with other geometric parameters of the magnetic core remaining unchanged. It is observed from FIG. 7 that the magnetic core direct current bias point B_{c,dc} is only 0.2 T at I_{dc} of 1000 A (Bₛₐₜ=0.52 T). Since the magnetic core is not saturated, the induced voltage V_{oc} and load power P_{L} always increase with I_{dc} (I_{ac}=0.3% I_{dc}). The experimental results agreed well with the calculated results. The designed non-invasive harmonic magnetic field energy harvesting device for the HVDC transmission line achieves a load power of 25.79 mW and a power density of 0.279 mW/cm³ under the conditions of I_{dc}=1000 A, I_{ac}=3 A/600 Hz.

The above general description of the disclosure involved in the present disclosure and the description of specific embodiments thereof should not be construed as limiting the configuration of the technical solutions of the present disclosure. According to the contents disclosed in the present disclosure, those skilled in the art may add, subtract, or combine the technical features disclosed in the above general description or/and specific embodiments (including examples) without violating the constituent elements of the disclosure to form other technical solutions within the scope of protection of the present disclosure.

1. A non-invasive harmonic magnetic field energy harvesting device for a high voltage direct current (HVDC) transmission line, comprising: an arc-shaped magnetic core and flux collectors;
wherein the arc-shaped magnetic core is located at the center of the device and the flux collectors are located at both ends of the arc-shaped magnetic core, and the device is placed near the transmission line without being snapped onto the transmission line.

2. The device according to claim 1, wherein the arc-shaped magnetic core is preferably a non-closed arc-shaped magnetic core.

3. The device according to claim 2, wherein the effective permeability of the non-closed arc-shaped magnetic core is much lower than that of a closed toroidal magnetic core.

4. The device according to claim 1, wherein the device harvests alternating harmonic magnetic field energy from the HVDC transmission line based on the principle of electromagnetic induction.

5. The device according to claim 1, wherein a method based on the device comprises the following steps: denoting the external direct current magnetic field strength generated by a direct current in the HVDC transmission line as H_{e,dc}, and denoting an effective value of the external alternating magnetic field strength generated by a harmonic current as H_{e,ac}; and
obtaining H_{e,dc} and H_{e,ac} through the following formulas:
$${H}_{e , dc} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} )$$
$${H}_{e , a c} = \frac{1}{{a}_{p}} {\int }_{r - \frac{{a}_{p}}{2}}^{r + \frac{{a}_{p}}{2}} \frac{{I}_{dc}}{2 π ρ} d ρ = \frac{{I}_{dc}}{2 π {a}_{p}} ln ( \frac{r + {a}_{p} / 2}{r - {a}_{p} / 2} ) ,$$
wherein I_{dc} and I_{ac} are the effective values of the direct current and the harmonic current in the line, respectively, r is the radius of the arc-shaped magnetic core, aₚ is the side length of the flux collector, and ρ represents a distance from the center of the cross section of the HVDC transmission line to any point on the flux collector.

6. The device according to claim 1, further comprising: a coil and a load resistor.

7. The device according to claim 6, wherein the alternating magnetic field generated by the harmonic current generates an induced voltage in the coil based on the principle of electromagnetic induction and outputs power to the load resistor.
